(19) United States
(12) Patent Application Publication
(10) Pub. No.: US 2024/0152625 A1
(43) Pub. Date: May 9, 2024

(54) Locating Potentially-Exploitable Software Dependencies

(71) Applicant: CodeNotary Inc., Bellaire, TX (US)

(72) Inventors: Moshe Bar, Houston, TX (US); Dennis Zimmer, Kuessnacht am Rigi (CH)

(73) Assignee: CodeNotary Inc., Houston, TX (US)

(21) Appl. No.: 18/385,903

(22) Filed: Oct. 31, 2023

Related U.S. Application Data
(60) Provisional application No. 63/421,152, filed on Oct. 31, 2022.

(51) Int. Cl. G06F 21/57; G06Q 10/0875

(52) U.S. Cl. CPC G06F 21/577; G06Q 10/0875

(57) ABSTRACT

Disclosed is an SBOM-reporting software program product that generates dynamic software bill of materials (SBOM) data for a software application during execution of the software application. Dynamic SBOM data identifies currently loaded dependencies of the software application. The program instructions for generating dynamic SBOM data are included in the software application. Also disclosed is a computer system for locating potentially-exploitable software dependencies comprising one or more computers comprising one or more SBOM-reporting software applications programmed to generate dynamic SBOM data. The computer system includes an SBOM server that can request of receive dynamic SBOM data from the SBOM-reporting software applications and may also include an SBOM collector that collects dynamic SBOM data from the SBOM-reporting applications.

This application claims the benefit of U.S. Provisional Application No. 63/421,152, filed on Oct. 31, 2022. The contents of the foregoing application (including supplemental materials) are incorporated in their entirety.

### COMPUTER PROGRAM LISTING APPENDIXES

With this application, Applicant has also submitted via EFS-WEB the following three ASCII text file appendices containing computer program listings: (a) java-truesbom-code.txt containing 3,454 bytes, and created or before Oct. 27, 2022; (b) coldjson.txt containing 96,908 bytes, and created Oct. 29, 2023 (from a .json file created on or before Oct. 27, 2022); and (c) hot.json.txt containing 123,102 bytes, and created Oct. 29, 2023 (from a j son file created on or before Oct. 27, 2022). The contents of these text files are incorporated in their entirety.

### FIELD OF THE INVENTION

The field of the invention is the creation and use of software bills of materials.

### BACKGROUND

A software bill of materials (SBOM) is a formal machine-readable inventory of software components and dependencies, information about those components, and their hierarchical relationships. These components can be publicly available open source software (OSS), purchased commercial off the shelf (COTS) libraries from a 3rd party, internal shared common code modules, or proprietary software, and may be widely available or access restricted. Each of the included components is one element of the SBOM for the software being developed. The collection of all the elements makes up the full SBOM.

An SBOM is effectively a nested inventory, a list of ingredients that make up software components. An SBOM identifies and lists software components, information about those components, and supply chain relationships between them. The amount and type of information included in a particular SBOM may vary depending on factors such as the industry or sector and the needs of SBOM consumers. SBOMs may include baseline attributes with the ability to uniquely identify individual components in a standard data format.

FIGS. 1 and 2 illustrate exemplary conceptual representations of an SBOM. In FIG. 1 and FIG. 2, the SBOM authored by Acme for the component named “Acme Application” has four components. One of these, the primary component, is the Acme Application, which defines the subject of the SBOM. Acme makes a component named “Application” that uses two upstream components, Bob's Browser and Bingo Buffer.

The data fields in FIG. 2 include the supplier's name, component name, version of the component (meaning the identifier used by the supplier to specify a change in software from a previously identified version), other unique identifiers (UIDs) that may be used to directly or indirectly identify a component, the author of the SBOM Data, and the dependency relationship.

An SBOM should enumerate first-level components that a supplier directly includes in the primary component. An SBOM ideally should capture nested supply chain relationships between components, to the extent that these relationships are known. An SBOM may support or describe an inclusion relationship (includes or included in). An upstream component (a dependency) is included in a downstream component. A dependency may include a library, module, package or other container, imported classes or functions, a device driver, configuration file, database, platform, appserver, plugins, or any other component that is included in a downstream component or which the downstream component needs or relies on to work properly. In FIG. 1, Bingo Buffer is an upstream dependency of Acme Application, Bingo is an upstream supplier to Acme.

While upstream components are typically included to provide functionality in a software application, it is common for parts of the component to not be used. For example, a software program (component) might include a library (component), but only call some of the functions provided by the library, or certain features of a component may be disabled during build or packaging.

It is possible to develop an SBOM as part of the software development process. Many software development tools provide automated SBOM creation and maintenance. Once the software for a product is released, by definition the SBOM content for that product is also considered complete. An SBOM is associated with a single release of software, and each newly released version of code requires a new SBOM. For older software, less-automated methods exist. There are software analysis tools (e.g., software composition analysis) that can generate an SBOM by analyzing source code and other information present in the development process at compile-time or build-time. When source code is not available, there are tools and method, including binary composition analysis, that analyze binary or executable code to extract dependency information.

An SBOM generated by any of these methods can be called a Static SBOM because it identifies (or attempts to capture) the components and dependencies of an application by inspecting or analyzing static code—for example source code, container images or binary code—that not active or not being executed. But a static SBOM is just a snapshot in time of the components of an application. There is no guarantee that a static SBOM is truly up to date or that it includes the true, full list of contents of an application when it is running or being executed. This presents two different problems. One problem is that a static SBOM may include dependencies that exist at compile time but are never loaded or executed during run-time, e.g., when the application is running or being executed. That will lead to a lot of noise when it comes to vulnerability detection as there are many false positives. Another problem is that a static SBOM will not include dependencies that are not known or discoverable at compile or build time. For example, libraries can be hidden in the source code (e.g., during compile time) as encrypted files. These hidden libraries can be used to introduce malicious code or other security vulnerabilities that manifest only after the libraries are decrypted and loaded during runtime.

A dynamic SBOM, by contrast to a static SBOM, refers to an SBOM that identifies (or includes identification data) for the components and dependencies of a software application that are loaded during run-time, while the application is being run or executed.

SBOMs can be an important resource in combatting software supply chain attacks against networks and critical business and government infrastructure. A good example is the exploitation of vulnerabilities in Log 4j, a highly popular logging framework, which infected hundreds of thousands of applications and the businesses and governments running it. Although the source of the vulnerability in Log 4j was identified and patches were developed and new versions released to correct or mitigate the vulnerability, the Log 4 vulnerabilities could not be eradicated until the consumers and users of Log 4j could locate every instance of Log 4j in their deployed applications. Without SBOMs or access to source code it is not possible to understand what libraries, components or other dependencies are being used in software.

However, a static SBOM cannot identify all potentially-exploitable dependencies of an application or software vulnerability. From a network security or supply chain security perspective, a vulnerability is not exploitable unless and until it is loaded and executed in an application. While not every dependency has vulnerabilities, a software dependency must be loaded to be potentially exploitable. A static SBOM does not report all loaded—and potentially exploitable—instances of a dependency. For example, it would be difficult to discover all exploitable instances of Log 4j by using a static SBOM because the code may be deeply embedded in an application or contained in other hidden dependencies, and because the Log 4j vulnerability is not exploitable unless specific functions with Log 4j are invoked or triggered during runtime.

There are significant technological challenges in generating a an SBOM for an application while it is being run, and different tools or methods may be developed to generate a dynamic SBOM for an application. To encourage widespread deployment and network effects, there is a need for a simple and standardizable method or tool to generate dynamic SBOMs.

Cataloguing the components of an application is only part of the challenge. A 2020 analysis by Github indicated that an average Github project includes 700 dependencies; commercial or enterprise-level applications will exceed this number. Some dependencies are used in multiple different applications. A commercial enterprise or data center could easily deploy thousands or hundreds of thousands of applications. And at any time, there may be multiple different versions of a dependency in thousands or hundreds of thousands of different deployments of hundreds or thousands of different applications. It is a task of staggering technological complexity and difficulty to keep track of which version of a dependency is deployed and where. Accordingly, there is a need for an efficient and standardizable means of collecting and storing SBOM data for potentially-exploitable dependencies.

### SUMMARY

An SBOM-reporting software program product is embedded in non-transitory computer-readable medium. When executed by a processor, the software program product generates dynamic software bill of materials (SBOM) data for a software application during execution of the software application and outputs the dynamic SBOM data to a client via a communications network. The program instructions for generating and outputting the dynamic SBOM data are included in the software application. Dynamic SBOM data may include data identifying all accessible and currently-loaded dependencies of the software application.

A computer system for locating potentially-exploitable software dependencies comprises one or more computers comprising one or more SBOM-reporting software applications. An SBOM-reporting software application is programmed to generate dynamic SBOM data for itself and report it. Dynamic SBOM data may include data identifying all loaded dependencies of the SBOM-reporting software application. The computer system includes a computer-implemented SBOM server that is programmed to receive dynamic SBOM data from SBOM-reporting software applications and store the dynamic SBOM data in a database. In embodiments, the SBOM-reporting software application can provide the dynamic SBOM data in response to a request from the SBOM server or it can upload it to the SBOM server. In embodiments, the computer system may also include an SBOM collector that collects dynamic SBOM data from the one or more SBOM-reporting applications. In an embodiment, the SBOM-reporting application includes an SBOM module that performs generating and reporting the dynamic SBOM data for the application. The dynamic SBOM data may identify the SBOM module as a currently-loaded dependency of the software.

### BRIEF DESCRIPTION OF THE DRAWINGS

The detailed description may refer to the following drawings, wherein like numerals refer to like elements, and wherein:

FIG. 1 illustrates an exemplary conceptual representation of an SBOM.

FIG. 2 illustrates an exemplary conceptual tabular representation of an SBOM.

FIG. 3 illustrates exemplary source code for an exemplary embodiment of an SBOM-reporting software application.

FIG. 4 is a conceptual illustration of reporting a dynamic SBOM.

FIG. 5 illustrates an exemplary embodiment of a computer system for locating potentially-exploitable software dependencies.

FIG. 6 illustrates an alternative exemplary embodiment of a computer system for locating potentially-exploitable software dependencies.

FIG. 7 illustrates an alternative exemplary embodiment of a computer system for locating potentially-exploitable software dependencies.

FIG. 8 illustrates an exemplary method of generating a dynamic SBOM.

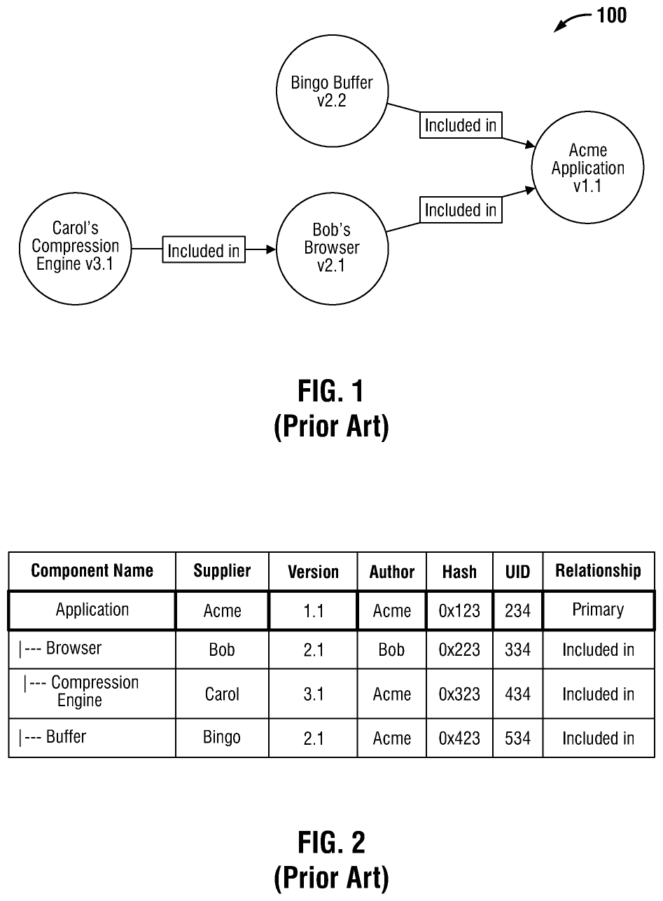

### DETAILED DESCRIPTION

In an embodiment, an SBOM-reporting software module may be incorporated in the source code of any software application. The SBOM-reporting software module is specific to the programming language and runtime environment of the application software and includes source code that compiles or is transformed into executable program instructions that execute with the application and generate a dynamic SBOM for the application while the application is being executed. The dynamic SBOM data identifies currently-loaded dependencies of the application, thereby revealing potentially-exploitable software dependencies of the application. The SBOM-reporting software module also includes source code to perform uploading the SBOM data to a collecting service. The SBOM-reporting software module listens to a specified port and upon request sends the SBOM data to an SBOM-collecting service. The SBOM-reporting software module also may initiate (or self-report) the upload of SBOM data to an SBOM collecting service at scheduled times or upon the occurrence of scheduled events. The SBOM data may be formatted in a machine-readable JSON data structure and may conform to standardized SBOM formats.

A central or distributed service can be used to collect, version and store all collected or received SBOM information over time. The platform or service may be hosted on an SBOM server. The SBOM server may poll SBOM-reporting software modules for dynamic SBOM data, or it may receive dynamic SBOM data uploaded by SBOM-reporting software modules. SBOM information may be collected by an SBOM collector that polls SBOM-reporting software modules for dynamic SBOM data and provides it to the SBOM server or the central or distributed service hosted on the SBOM server. SBOM collection can be fully automated, whenever a new application goes live that provides a SBOM. The central or distributed service can be used to locate and identify loaded dependencies.

The solutions described here solve critical technological problems in modern computer network security and software supply chain management. For any software language or runtime environment there may be many ways to generate a dynamic SBOM. Some of these may be more efficient or smaller or better than others. But widespread deployment of SBOM-reporting applications is more important than the specific method by which the SBOM is generated in any specific application. Because the SBOM-reporting software modules can be customized for any language or runtime environment and are simple to incorporate into source code for any software application or component, software developers can quickly and easily add SBOM-reporting functionality to their applications. Features such as use of the same communications port and protocol for requesting and providing SBOM data provide a standardized interface for providing and collecting dynamic SBOM data independent of the original development environment and software language, the application runtime environment, and the type of application. When there is a need to identify all instances and locations of a software dependency—for example, when it is discovered that a specific software dependency may be vulnerable to an attack or failure mode—the central or distributed service can used to quickly locate and identify all loaded (and hence exploitable) instances of the dependency to remove, neutralize or mitigate the vulnerability. The solutions described here, in short, provide an easy way for any application developer to add SBOM-reporting capability to an application during development and harmonizes and standardizes a method of invoking generation of a dynamic SBOM and retrieving or forwarding the SBOM to a central platform for analytics and traceability.

FIG. 4 is a conceptual illustration of aspects of an embodiment of reporting a dynamic SBOM. At any moment of time when Application 410 is running (or being executed as a computational process), Application 410 may include one or more loaded dependencies 420 and accessible dependencies 430.

Loaded dependencies 420 may include any number or type of dependencies, illustrated here as dependencies 423, Dep1 to Dep5. SBOM-reporting module (or SBOM reporter) 425 may be a loaded dependency.

The loaded dependencies 420 may include software components or dependencies present at compile-time, for example, the code and libraries incorporated in the original application source code. The loaded dependencies 420 may include other or additional software components or dependencies that were added to the application or container image at build time. These components and dependencies that were present at compile-time or build-time may be included in a static SBOM for application 410. SBOM-reporting module 425 may be included in a static SBOM for application 410. While application 410 may be able to generate and report an SBOM through the functionality provided by SBOM-reporting module 425, the primary purpose or valuable aspect of application 410 may be unrelated to generating and reporting an SBOM. The source code of application 410 unrelated to SBOM-reporting module 425 may be unrelated to generating and reporting an SBOM.

The loaded dependencies 420 may include hidden dependencies or runtime dependencies that are only visible when loaded after the application has been launched and is running or being executed in a computational process. Some hidden dependencies may become visible when a function is executed. A hidden dependency may become visible when a timebomb or other artifact of malicious code is executed. A hidden dependency may include a dependency that is nested in the application and loaded on demand, e.g., in an archive that is part of the application. A hidden dependency may be located online and loaded on demand. A hidden dependency may be updated when the application is launched. A hidden dependency may be created during the application runtime and loaded on demand. Loaded dependencies should be identified because a vulnerability in a dependency may not be exploitable unless it is loaded. A static SBOM of application 410 would be of limited use in locating potentially-exploitable dependencies because it would not identify hidden dependencies or runtime dependencies (false negatives) and it may identify accessible or static dependencies that may never be loaded (false positives). For example, a vulnerability in a software library may be limited to a specific routine. If the specific library routine is never actually loaded by an application, it may not be necessary to update the entire library.

Identification of loaded dependencies empowers the user to focus remedial efforts on components that are actually used as opposed to accessible. The user can focus his or her efforts on locating, patching, or updating actively-loaded dependencies before they are exploited, and does not have to spend time focusing on dependencies that may never be loaded, executed, or exploited. In some cases, e.g., a zero-day vulnerability, time is of the essence, and the ability to immediately focus on the known potentially-exploitable dependencies makes the difference between repulsing or succumbing to the vulnerability.

Accessible dependencies 430 may include dependencies that were compiled or otherwise incorporated or embedded into the application but are not loaded when the SBOM is generated. Dependencies that are accessible but not loaded may be included in the SBOM for completeness. Information about accessible dependencies may also identify dependencies that could be currently-loaded at a different point of time. A static SBOM may include dependency details for accessible dependencies 430. A static SBOM for application 410 may include dependency details for SBOM-reporting module 425.

The SBOM-reporting module 425 may collect or retrieve dependency data for the loaded dependencies 420. The SBOM-reporting module 425 may collect or retrieve dependency data for the accessible dependencies 430. The SBOM-reporting module 425 may collect or retrieve dependency data for the loaded dependencies 420 and accessible dependencies 430. In an embodiment, SBOM-reporting module 425 detects and reports the difference between loaded or active dependencies and dependencies shown in a static SBOM for the application 410. SBOM-reporting module 425 may capture the exact libraries used by application 410, even if they are in the platform, appserver, plugins, or anywhere else. This approach may include details of services invoked and which libraries are active.

SBOM or SBOM data 450 may include dynamic SBOM data for application 410, including one or more loaded dependencies 420. The dependency data for the loaded dependencies 420 may include dependency data for the SBOM-reporting module 425 itself. The dependency data or dependency identification data 450 reported by the SBOM-reporting module 425 may include one or more of the following: timestamp, supplier name; component name; version of the component; cryptographic hash of the component; any other unique identifier; dependency relationship; author of the SBOM data. The SBOM or SBOM-data may include data in any data field supported by a standardized SBOM format such as Software Package Data Exchange (SPDX) or CycloneDX (or CDX). The SBOM or SBOM data may contain metadata that includes the application name and version, the dependency's name and version, and the hostname and address of the computer hosting the SBOM-reporting application or the IP address of the SBOM-reporting module. In case of Google Functions and other runtime environments that are ephemeral, the SBOM may be provided to a centralized service with name and version of the application and the environment information (e.g., Lambda or Google function).

The SBOM-reporting module 425 may format the dependency data for output or return as an SBOM or SBOM data 450. The SBOM-reporting module 425 may format the dependency data in a standardized SBOM format, for example, SPDX or CycloneDX.

Embodiments of the SBOM-reporting module 425 may report, e.g., output or return, SBOM or SBOM data: (a) as plain text; (b) in a machine-readable data format; (c) in a human-readable data format; (d) in a language-independent data format; or (e) Java Standard Object Notation (JSON) data structure. The SBOM-reporting module 425 may report the SBOM or SBOM data as a machine-readable JSON object. The SBOM-reporting module 425 may report dependency data relating to loaded dependencies 420 separately from dependency data relating to accessible dependencies 430. The SBOM-reporting module 425 may report dependency data relating to loaded dependencies 420 that are potentially exploitable. SBOM or SBOM data 450 may differentiate between loaded dependencies 420 and accessible dependencies 420. The SBOM or SBOM data 450 may describe each dependency and its state (e.g., loaded, not loaded). The SBOM module 425 may report or export the SBOM information 450 on a specified TCP port, for example, port 8001, using HTTP protocol.

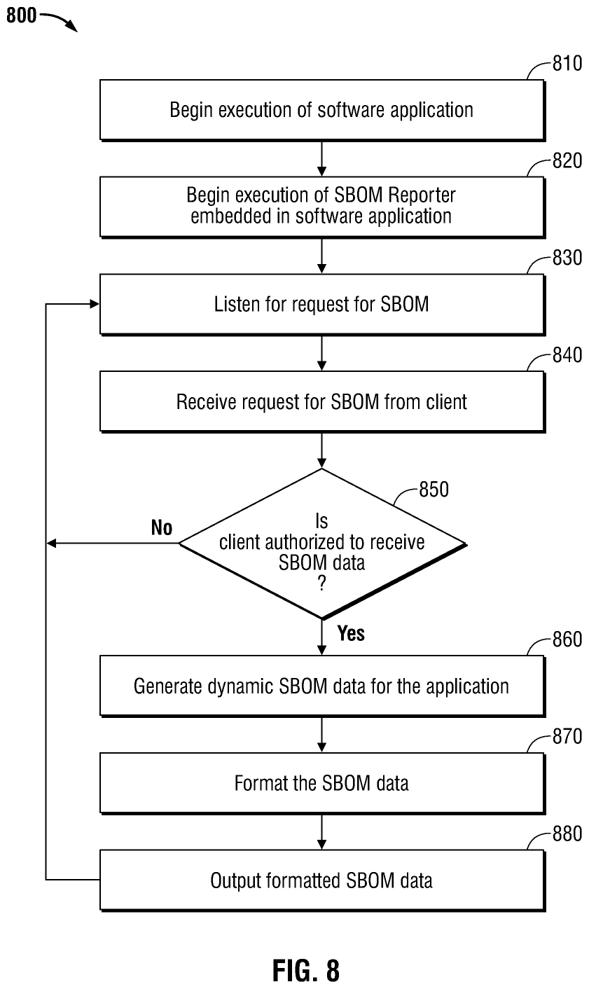

FIG. 8 illustrates an exemplary method 800 of generating a dynamic SBOM. Method 800 may be expressed in software code or program instructions included in a runtime software library, software program, package or module that is incorporated in a software application. In step 810, a software application is launched and begins execution. Execution of the software application may occur in an active computing process.

In step 820, the SBOM-reporting module component of the software application may begin execution. The source code for the SBOM-reporting module may have been contained in a software library, package or module that is imported, included, embedded or incorporated in the source code for the software application. The binary code, executable code, or program instructions for the SBOM-reporting module code may be contained in or integrated or combined with the binary code, executable code, or program instructions for the software application. Execution of the software application may include initiating execution of the SBOM-reporting module. The SBOM-reporting module may execute in the same active computing process as the software application.

In step 830, the SBOM-reporting module code may begin listening for a request for an SBOM. The SBOM-reporting module code may listen on a TCP port for requests conforming to the HTTP protocol. The TCP port may be exposed to an HTTP client. The default port number may be 8001. The port number may be specified in the source code. In step 840, a request for an SBOM is received from a client via the port.

The request for an SBOM may include authentication credentials, which are checked in step 850 to confirm that the client is authorized to receive SBOM data. The SBOM-reporting module may invoke native authentication protocols and methods to confirm that the client is authorized. The SBOM-reporting module may use more restrictive authentication protocols in place or in addition to native authentication protocols and methods. In an embodiment, the request to the port (e.g., TCP Port 8001) may be authenticated. The authentication protocol may include HTTP Basic Access Authentication. The request may send BASIC authentication data to receive the dynamic SBOM. The statement “curl https://myapp:8001 -u “user:password” may be used. The SBOM-reporting module include configurable authentication settings. The required or authorized user and password may be configured in the SBOM-reporting module using a _USER environment variable or flag, for example, SBOM_USER. The SBOM_USER variable may contain the user:password combination base64-encoded. If the client is not authorized, the SBOM-reporting module code may stop processing the request and resume listening for an SBOM request. Otherwise, the SBOM-reporting module will proceed to step 860.

In step 860, the SBOM-reporting module code may generate dynamic SBOM data for the software application. The dynamic SBOM data may include data identifying every loaded dependency of the Application at the time of the request. The dynamic SBOM data may include data identifying every accessible dependency of the application at the time of the request. In an embodiment, the dynamic SBOM data may include data identifying one or more loaded or accessible dependencies of the application. The dynamic SBOM-reporting module code may call or invoke other SBOM retrieval code to generate the dynamic SBOM data. The dynamic SBOM-reporting module code or the SBOM retrieval code may rely on native functionality provided by the runtime environment of the application or operating system in whole or in part to generate the dynamic SBOM data. The SBOM retrieval code may include code specifically designed to retrieve dynamic SBOM data for a software process running locally. The SBOM retrieval code for a Java application may include the jbom code library published by Eclipse as an exemplary tool to generate a dynamic SBOM.

In step 870, the SBOM data may be transformed or converted into a specified format and content type. The SBOM data may be formatted into a conventional SBOM data format, which may include SPDX or CycloneDX. The SBOM data may be structured in a JSON data structure. In step 880, the formatted dynamic SBOM data may be outputted or returned to the client.

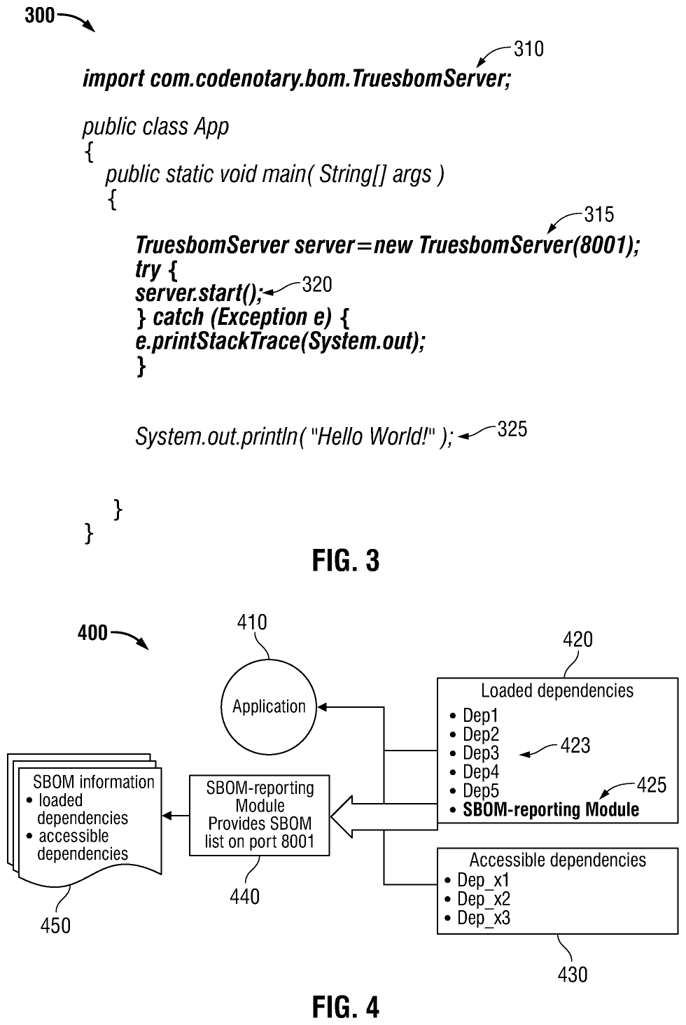

FIG. 3 illustrates an exemplary embodiment of source code for an exemplary SBOM-reporting software application 300, which illustrates how an SBOM-reporting module may be included in source code for a software application. The source code for exemplary application 300 includes an exemplary hypothetical software module named “TrueSBOM” that performs a server function of returning SBOM data upon request. In line 310, an exemplary Java class named “TrueSBOM” is imported (included) in the source code 300. In line 315, a new instance of a TrueSBOM server object named “Server” is created with TCP port number 8001 as a parameter. The code begins execution of the server object (320). During execution, when a client request comes in on port 8001, the SBOM is generated and returned to the client.

The software, code, and program instructions for implementing the functions performed by the exemplary Server instance of the TrueSBOM class may perform launching the server instance, activating port 8001, listening for client requests on port 8001, receiving a client request for an SBOM, receiving authentication information, retrieving dependency data for dependencies of application 300, formatting the dependency data into SBOM data, and returning the SBOM data to the client on port 8001. In FIG. 3. Dependency data for the “TrueSBOM” software module may be included in the dependency data for software application 300.

The software, code, and program instructions for implementing the functions performed by the server instance of the TrueSBOM class may be written in Java. The software, code, and program instructions for implementing the functions performed by the Server instance of the “TrueSBOM” class may employ code, tools, dependencies, and techniques of the Java development environments. The software, code, and program instructions for implementing the functions performed by the Server instance of the “TrueSBOM” class may employ code, tools, dependencies, libraries and the like, and techniques provided by the operating system or native to the runtime environment of the computer on which software application 300 is to be executed. The exemplary Java application source code 300 outputs “Hello World” (325).

As the SBOM-reporting module may be part of the application binary, tamperproofing measures may be used to guarantee the integrity of the application. Tamperpoofing measures may include storing a hash value of the application binary in an immutable ledger database or use of digital certificates for code signing. Tamperproofing measures may ensure that there is no way to remove the SBOM-reporting module or tamper with the output of the SBOM-reporting service unnoticed.

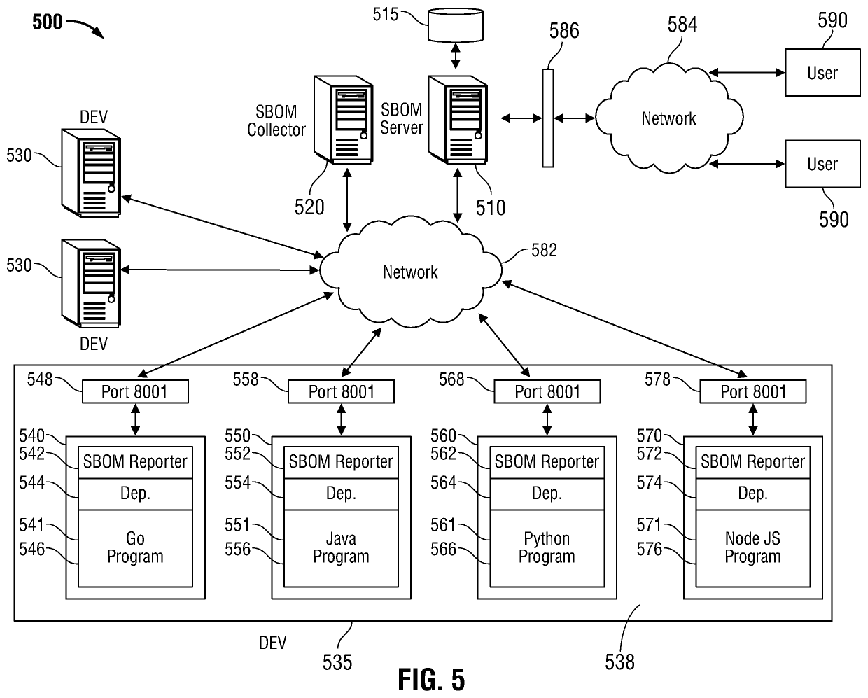

FIG. 5 illustrates an exemplary embodiment of a computer system 500 for locating potentially-exploitable software dependencies. Computer system 500 may include an SBOM server 510 connected via network 582 to one or more devices (or computers) 530, including exemplary computer 535. A device 530 may include a computer. Computer system 500 may include SBOM collector 520 connected via network 582 to one or more computers (or devices) 530. In another embodiment, SBOM collector 520 may not be present in computer system 500. SBOM server 510 may perform one or more functions performed by SBOM collector 520.

Exemplary computer 535 may execute or run one or more software applications 538, including exemplary applications 540, 550, 560, and 570. The one or more software applications 538 may perform different functions and may have been written in different software languages, originated from different development platforms, or execute in different runtime environments and operating systems. The one or more software applications 538 may include software applications containing embedded SBOM-reporting modules (or SBOM-reporting code). The term SBOM-reporting application (or SBOM-reporting software application) refers to a software application that is programmed to generate and report, return, or output, upon request or on its own initiation, an SBOM or SBOM data that includes SBOM data or dependency-identification data for currently-loaded dependencies. An SBOM-reporting application may generate and report, return or output SBOM or SBOM data or regarding accessible dependencies in addition to information regarding currently-loaded dependencies. An SBOM-reporting application may contain an SBOM-reporting module or SBOM-reporting code that performs generating and returning or outputting, the SBOM or SBOM data. An SBOM-reporting module or SBOM-reporting application may perform formatting the SBOM or SBOM data. The one or more computers 530 may include one or more SBOM-reporting applications that perform different functions and may have been written in different software languages, originated from different development platforms, or execute in different runtime environments and operating systems.

Exemplary Go software application 540.

Exemplary software application 540 is a Go application, and all or part of the source code for application 540 was written in Go. When application 540 is being executed by computer 535, the runtime environment 541 may include binary (or executable) code for the application 546, one or more loaded or accessible dependencies 544, and Go SBOM-reporting module 542.

The Go SBOM-reporting module 542 may be programmed to generate a dynamic SBOM for application 540 at runtime, that is, while application 540 is being executed in an active computing process by computer 535. The Go SBOM-reporting module 542 may be programmed to generate a SBOM for application 540 at runtime using compile time SBOM creation and embedding. The Go SBOM-reporting module 542 may be programmed to invoke another function developed and specific to the Go software development or runtime environment to generate a dynamic SBOM for application 540 at runtime. The SBOM generated by Go SBOM-reporting module 542 may include the one or more loaded or accessible dependencies 544. The dynamic SBOM generated by Go SBOM-reporting module 542 may identify Go SBOM-reporting module 542 as one of the one or more loaded dependencies 544. The Go SBOM-reporting module 542 may be executed in the same computing process as application 540.

The Go SBOM-reporting module 542 may be programmed to expose communications port 548 to HTTP clients and to receive SBOM requests over port 548. The Go SBOM-reporting module 542 may be programmed to report the dynamic SBOM to SBOM server 510 over network 582 via communications port 548. Go SBOM-reporting module 542 may be programmed to report the dynamic SBOM to SBOM Collector 520 over network 582 via port 548. Communications port 548 may be TCP port 8001.

The source code for Go SBOM-reporting module 542 may have been written in whole or in part in Go. The source code for Go SBOM-reporting module 542 may have been included in a Go module that was included or incorporated in the source code for application 540 when it was compiled. Go SBOM-reporting module code may have been combined with other Go application code when application 540 was built.

Exemplary Java software application 550.

Exemplary software application 550 is a Java application, and all or part of the source code for application 550 was written in Java. When application 550 is being executed by computer 535, the runtime environment 551 may include binary (or executable) code for the application 556, one or more loaded or accessible dependencies 554, and Java SBOM-reporting module 552.

Java SBOM-reporting module 552 may be programmed to generate a dynamic SBOM for application 550 at runtime, that is, while application 550 is being executed in an active computing process by computer 535. Java SBOM-reporting module 552 may be programmed to generate a dynamic SBOM for application 550 at runtime by scanning for classpath data (to identify accessible dependencies) and using Java's reflection mechanism to identify active dependencies. The metadata may mark the active dependencies different from the ones identified in the classpath. Java SBOM-reporting module 552 may be programmed to generate a dynamic SBOM for application 550 at runtime by incorporating the eclipse jbom Java library. (The source code for the eclipse jbom Java library can be obtained from https://github.com/eclipse/jbom and is hereby incorporated by reference). Java SBOM-reporting module 552 may be programmed to generate a dynamic SBOM for application 550 at runtime by incorporating another library or dependency that generates dynamic SBOMS. Java SBOM-reporting module 552 may be programmed to invoke another class or function developed and specific to the Java software environment or runtime environment to generate a dynamic SBOM for application 550 at runtime. The dynamic SBOM generated by Java SBOM-reporting module 552 may include the one or more loaded or accessible dependencies 554. The dynamic SBOM generated by Java SBOM-reporting module 552 may identify Java SBOM-reporting module 552 as one of the one or more loaded dependencies 554. Java SBOM-reporting module 552 may be executed in the same computing process as application 550.

Java SBOM-reporting module 552 may be programmed to expose communications port 558 to HTTP clients and to receive SBOM requests over port 558. Java SBOM-reporting module 552 may be programmed to report the dynamic SBOM to SBOM server 510 over network 582 via port 558. Java SBOM-reporting module 552 may be programmed to report the dynamic SBOM to SBOM Collector 520 over network 582 via port 558. Communications port 558 may be TCP port 8001.

The source code for Java SBOM-reporting module 552 may have been written in whole or in part in Java. The source code for Java SBOM-reporting module 552 may have been included in a Java dependency that was included or incorporated in the source code for application 550 when it was compiled. Java SBOM-reporting module code may have been combined with other Java application code when application 550 was built.

Exemplary Python software application 560.

Exemplary software application 560 is a Python application, and all or part of the source code for application 560 was written in Python. When application 560 is being executed by computer 535, the runtime environment 561 may include binary (or executable) code for the application 566, one or more loaded or accessible dependencies 564, and Python SBOM-reporting module 562.

Python SBOM-reporting module 562 may be programmed to generate a dynamic SBOM for application 560 at runtime, that is, while application 560 is being executed in an active computing process by computer 535. Python SBOM-reporting module 562 may be programmed to generate a dynamic SBOM for application 560 at runtime by scanning for loaded modules. Python SBOM-reporting module 562 may be programmed to use the running Python processes and generate the component list based on site packages used by Python processes. Python SBOM-reporting module 562 may be programmed to use the pycomponents package available from github at: https://github.com/ninoseki/pycomponents/tree/main. Python SBOM-reporting module 562 may be programmed to invoke another function developed and specific to the Python software environment or runtime environment to generate a dynamic SBOM for application 560 at runtime. The dynamic SBOM generated by Python SBOM-reporting module 562 may include the one or more loaded or accessible dependencies 564. The dynamic SBOM generated by Python SBOM-reporting module 562 may include Python SBOM-reporting module 562 as one of the one or more loaded dependencies 564. Python SBOM-reporting module 562 may be executed in the same computing process as application 560.

The Python SBOM-reporting module 562 may be programmed to expose communications port 568 to HTTP clients and to receive SBOM requests over port 568. The Python SBOM-reporting module 562 may be programmed to report the dynamic SBOM to SBOM server 510 over network 582 via communications port 568. The Python SBOM-reporting module 562 may be programmed to report the dynamic SBOM to SBOM Collector 520 over network 582 via port 568. Communications port 568 may be TCP port 8001.

The source code for Python SBOM-reporting module 562 may have been written in whole or in part in Python. The source code for Python SBOM-reporting module 562 may have been included in a Python module or package that was included or incorporated in the source code for application 560 when it was compiled. Python SBOM-reporting module code may have been combined with other Python application code when application 560 was built.

Exemplary NodeJS software application 570.

Exemplary software application 570 is a NodeJS application, and all or part of the source code for application 570 was written in NodeJS. When application 570 is being executed by computer 535, the runtime environment 571 may include binary (or executable) code for the application 576, one or more loaded or accessible dependencies 574, and NodeJS SBOM-reporting module 572.

NodeJS SBOM-reporting module 572 may be programmed to generate a dynamic SBOM for application 570 at runtime, that is, while application 570 is being executed in an active computing process by computer 535. NodeJS SBOM-reporting module 572 may be programmed to generate a dynamic SBOM for application 570 at runtime by scanning for loaded modules or packages. NodeJS SBOM-reporting module 572 may be programmed to generate a dynamic SBOM using the native NodeJS getLoadedModules( ) function. NodeJS SBOM-reporting module 572 may be programmed to invoke another function developed and specific to the NodeJS software environment or runtime environment to generate a SBOM for application 570 at runtime. The dynamic SBOM generated by NodeJS SBOM-reporting module 572 may include the one or more loaded or accessible dependencies 574. The dynamic SBOM generated by NodeJS SBOM-reporting module 572 may include NodeJS SBOM-reporting module 572 as one or more loaded dependencies 574. NodeJS SBOM-reporting module 572 may be executed in the same computing process as application 570.

The NodeJS SBOM-reporting module 572 may be programmed to expose communications port 578 to HTTP clients and to receive SBOM requests over port 578. The NodeJS SBOM-reporting module 572 may be programmed to report the dynamic SBOM to SBOM server 510 over network 582 via communications port 578. The NodeJS SBOM-reporting module 572 may be programmed to report the dynamic SBOM to SBOM Collector 520 over network 582 via port 578. Communications port 578 may be TCP port 8001.

The source code for NodeJS SBOM-reporting module 572 may have been written in whole or in part in NodeJS. The source code for NodeJS SBOM-reporting module 572 may have been included in a NodeJS module or library that was included or incorporated in the source code for application 570 when it was compiled. NodeJS SBOM-reporting module code may have been combined with other NodeJS application code when application 570 was built.

An SBOM-reporting module (e.g., exemplary SBOM-reporting modules 542, 552, 562, and 572) may receive a request for a dynamic SBOM from an SBOM server (e.g., SBOM server 510). An SBOM-reporting module may receive a request for a dynamic SBOM from an SBOM Collector (e.g., SBOM Collector 520). When it receives a request for a dynamic SBOM, an SBOM-reporting module may generate a dynamic SBOM for the software application in which it is embedded and return the dynamic SBOM to the SBOM server client (or service hosted on the SBOM server client) or SBOM collector client that requested it.

An SBOM-reporting module (e.g., exemplary SBOM-reporting modules 542, 552, 562, and 572) may generate a dynamic SBOM for the software application in which is embedded and upload or push the dynamic SBOM to the SBOM server (e.g., SBOM server 510). The SBOM-reporting module may self-report or generate the dynamic SBOM in the absence of a request by an SBOM server or SBOM collector. The SBOM-reporting module may be programmed to generate the dynamic SBOM upon the occurrence of a configurable event, e.g., start-up, power-loss, failure of self-check. The SBOM-reporting module may be programmed to generate the dynamic SBOM at configurable time intervals, e.g., every day at noon.

An SBOM-reporting module (e.g., exemplary SBOM-reporting modules 542, 552, 562, and 572) may expose a dynamic SBOM in a JSON data structure using a standardized SBOM format, e.g., SPDX or CycloneDX. The port values used by an SBOM-reporting module for communication with an SBOM server or SBOM collector, e.g., ports 548, 558, 568, and 578, may be user-configurable.

SBOM server 510 may be a computer or a computer system. SBOM server 510 may include or be coupled to one or more databases 515. One or more databases 515 may be hosted on one or more data stores coupled to SBOM server 510. The one or more databases 515 may include a SQL database, for example, postgresql, or other relational database. The one or more databases 515 may include a NoSQL database, e.g., mongodb. The one or more databases 515 may include a key-value store. The one or more databases 515 may include an immutable data store. SBOM server 510 may store dynamic SBOM data, which may include dependencies, and additional data in the one or more databases 515. SBOM server 510 may store all dynamic SBOM data provided by or collected from SBOM-reporting modules in the one or more databases 515. SBOM server 510 may reformat dynamic SBOM data from a conventional SBOM format into a format corresponding to the data records in the one or more databases 515. Additional data stored in the one or more databases 515 may include a timestamp, recording the date and time of the SBOM data assembly, information identifying the application corresponding to the SBOM, and the host name and address of the computer hosting the SBOM-reporting application or SBOM-reporting module, and integrity information, e.g., a hash-value of the SBOM or the database entries. Additional data stored in database 515 may include its runtime environment, Environment variables, server version (e.g., Apache Tomcat), framework name and version (e.g., OpenJDK).

SBOM server 510 may host a collection service. The collection service may collect, version, and store SBOM data in the one or more databases 515. The retention time for SBOM data and additional data may be configurable. SBOM data and additional data may be stored in the one or more databases 515 for a specified amount of time, permanently, or immutably.

SBOM server 510 may poll known SBOM-reporting modules (e.g., SBOM-reporting modules 542, 552, 562, 572) for dynamic SBOMs. SBOM server 510 may reformat and save the dynamic SBOM response from the SBOM-reporting module in database 515. SBOM server 510 may search for new SBOM-reporting modules. SBOM server 510 may search within the accessible IP range for open ports 8001 and try to collect a dynamic SBOM from each new open port 8001. SBOM server 510 may be configurable to limit its searching or scanning to specified or configured subnets or IP ranges (e.g., IP addresses within a specific network).

SBOM collector 520 may communicate with devices 530 (e.g., SBOM-reporting modules 542, 552, 562, 572) via network 582. SBOM collector 520 may communicate with devices 530 (e.g., SBOM-reporting modules 542, 552, 562, 572) via network 582 as an HTTP client via communication ports 548, 558, 568, 578. SBOM collector 520 may be hosted in computer 535.

SBOM collector 520 may poll (or scrape) SBOM-reporting modules (e.g., SBOM-reporting modules 542, 552, 562, 572) for dynamic SBOMs. SBOM collector 520 may store dynamic SBOM information and additional data retrieved from an SBOM-reporting module in data storage media on or local to the SBOM collector. Additional data may include a time stamp, information identifying the application corresponding to the SBOM, and the host computer and its address. SBOM collector 520 may provide dynamic SBOM data, which may be in a JSON file, and additional to SBOM server 510. SBOM server 510 may reformat the dynamic SBOM data transmitted by SBOM collector 520 and store it in database 515. The SBOM collector 520 may provide data collected from SBOM-reporting modules to the SBOM server 510 on a configurable schedule. The SBOM Collector 520 may search for new SBOM-reporting modules. The SBOM collector 520 may search within the accessible IP range for open ports 8001 and try to collect a dynamic SBOM from each new open port 8001. SBOM collector 520 may be configurable to limit its searching or scanning to specified or configured subnets or IP ranges (e.g., IP addresses within a specific network).

SBOM collector 530 may be integrated with SBOM server 510 and hosted and executed on the same computer as SBOM Server 510. SBOM server 510 may be programmed to perform the functions of SBOM collector 530. SBOM server 510 may include a built-in collector when all SBOM-reporting modules are accessible by SBOM server 510. The SBOM Collector 520 may be an independent software process from SBOM server 510. SBOM Collector 520 may be hosted or executed on a different computer from SBOM Server 510. SBOM Collector 520 may be hosted on the same computer as one or more SBOM-reporting software applications. SBOM Collector 520 may collect SBOM data from one or more SBOM-reporting computer applications hosted on the same computer as SBOM Collector 520.

SBOM server 510 may provide or expose SBOM data management and analytics services to one or more users 590 over a network 584. SBOM server may be protected from one or more users 590 by firewall 586.

The SBOM data management and analytics services provided on SBOM server 510 may include a search interface that supports user search queries to database 515 and filtration and review of search results.

The SBOM data management and analytics services provided on SBOM server 510 may provide a tracking service to search and filter for applications, application libraries, components, or currently loaded or accessible dependencies and where they have been located. For example, a user could use the SBOM data management and analytics services hosted on the SBOM server to search for any occurrence of a specified version of a specified dependency (e.g., log 4j) and get all applications including their location in return.

The SBOM data management and analytics services provided on SBOM server 510 may generate and deliver to users pre-formatted and/or configurable reports. Reports may reflect the current inventory of running applications and their libraries and dependencies currently used. A report could for example show that 80% of a certain application are already updated to the latest version in production, while 20% use older versions.

The SBOM data management and analytics services provided on SBOM server 510 may be configured to alert users when there is a change in SBOM data for specified computers, applications, or dependencies. The SBOM data management and analytics services provided on SBOM server 510 may be configured to alert users when a malicious, compromised or unwanted dependency, module, package or library is revealed in the loaded dependencies. The SBOM data management and analytics services provided on SBOM server 510 may support user configuration of the address where notification may be sent, the type and content of the application, and identifying information for the malicious, compromised, or unwanted dependency, module, package or library. Alert information may be used by a client to suspend or terminate deployment of an application containing a malicious, compromised, or unwanted dependency, module, package or library.

FIG. 6 illustrates an alternative exemplary embodiment of a computer system for locating potentially-exploitable software dependencies. Computer system 600 includes an SBOM server 610 coupled via network 628 to SBOM collectors 620, 625. SBOM server 610 may store SBOM on a data store (not shown). SBOM server 610 may perform the same or similar functions as SBOM server 510 (FIG. 5).

SBOM collector 620 is coupled via network 638 to SBOM-reporting applications (not shown) running on one or more computers 630. Computer system 600 may optionally include firewall 621 between SBOM collector 620 and network 628. Each computer 630 may include one or more SBOM-reporting applications. The one or more computers 630 may include different types of computers running different applications.

SBOM collector 625 is coupled via network 648 to SBOM-reporting applications (not shown) running on exemplary computers or computer-equipped devices, including desktop computer 641, laptop 642, smart phone 643, printer 644, car 645, and smart TV 646.

SBOM collectors 620, 625 may perform the same or similar functions as SBOM collector 520 (FIG. 5). An SBOM collector may search for SBOM-reporting modules by, for example, polling ports. An SBOM collector may be configured to detect and poll different types or groups of SBOM-reporting modules. For example, depending on user configuration, an SBOM collector may locate and poll SBOM-reporting modules in specific applications or versions of application, SBOM-reporting modules on specified computers, devices, SBOM-reporting modules at a specific IP address, SBOM-reporting modules on computers on a specific network or subnetwork, or SBOM-reporting modules on specific types of devices or computer-equipped devices.

An SBOM collector may be configurable. An SBOM collector may be configured to scan or scrape a certain subnet or certain ports within the network to find SBOM-reporting modules and collect the SBOMs from them. An SBOM collector may store SBOM data locally according to configurable local storage parameters. An SBOM collector may be configured to send collected SBOM data to a specified SBOM server. An SBOM collector may be configured to send collected SBOM data to an SBOM server at specified times or on a specified schedule. An SBOM collector may be configured using flags, for example, —subnet —port, or a local configuration file that reflects the flags.

Computer system topologies as illustrated in FIG. 6 may improve network security. For example, one or more computers 630 may include an SBOM-reporting application (not shown) that for security reasons should not be exposed a public network. A firewall (e.g., firewall 621) may be used to protect or insulate the SBOM-reporting applications located on a private or secured network. Deploying an SBOM collector (e.g., SBOM collector 620) behind the same a firewall (621) helps minimizes security risks arising from exposing SBOM-reporting applications to malicious probes over an open network and helps preserve confidentiality of proprietary or sensitive components. Computer system topologies as illustrated in FIG. 6 may be used to distribute the computational burden and network traffic caused associated with managing networks of thousands of SBOM-reporting applications distributed over thousands of different computers. Computer system topologies as illustrated in FIG. 6 may be used to improve or support network segmentation.

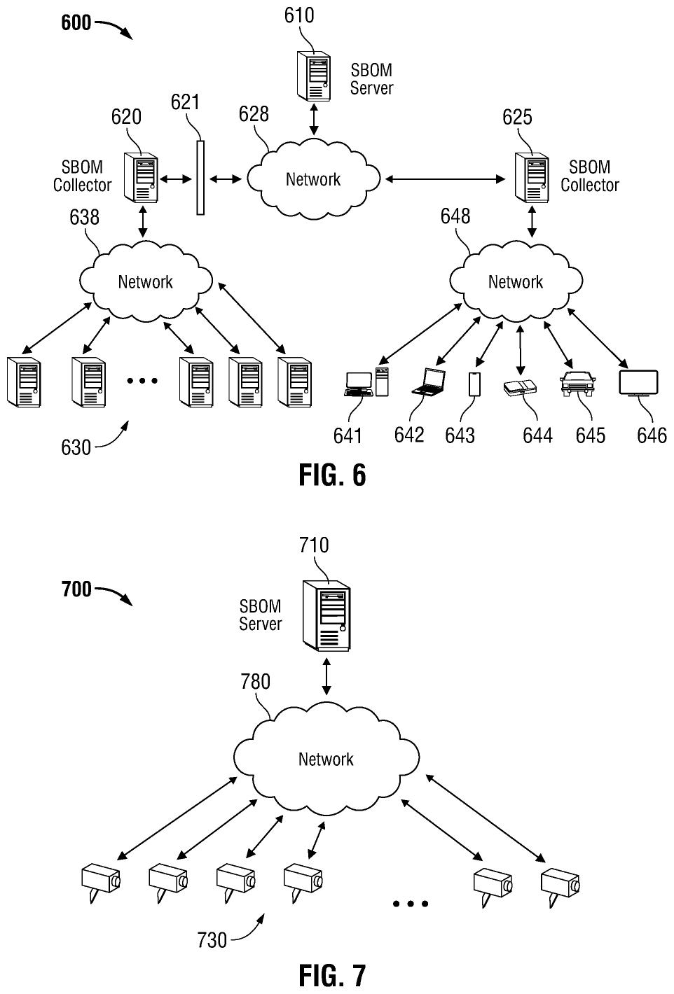

FIG. 7 illustrates an alternative exemplary embodiment of a computer system for locating potentially-exploitable software dependencies. Computer system 700 includes SBOM server 710 connected via network 780 to one or more SBOM-reporting applications (not shown) running on devices 730. A device 730 may be any computer-equipped sensor, appliance or other device and connected to a network. For a hypothetical example, device 730 may include a computer-equipped surveillance camera. SBOM server 710 may perform the same or similar functions as SBOM server 510 (FIG. 5) or SBOM server 610 (FIG. 6). SBOM server 710 may store SBOM on a data store (not shown). Computer system 700 may not include a SBOM collector. SBOM server 710 may collect dynamic SBOM data directly from devices 730. SBOM server 710 may collect dynamic SBOM data by polling devices 730. Computers or computer-equipped devices 730 may include identical or similar types of SBOM-reporting applications. Computers or computer-equipped devices 730 may include identical or similar types of computers. The one or more computers 730 may include different types of computers running different applications.

Computer system topologies as illustrated in FIG. 7 may be useful when the SBOM server is able to communicate with all SBOM-reporting applications of interest, for example, if there are no SBOM-reporting applications of interest behind a firewall. Then no separate collector is required, and the SBOM server may also perform the function of the SBOM collector.

A “computer system,” as used herein, includes software and hardware resources required to implement the methods described herein, and includes one or more computers. A computer may include computer program instructions that implement the methods described herein, at least one processing unit to execute or run the computer program instructions, memory to store data and computer program instructions during execution, persistent or non-transitory storage to store data and computer program instructions, and network/communication subsystems to network and communicate with other computers or computer systems. One or more computers may be virtual machines, virtual computers, or virtual computers that provide virtualized computing services. The computers may be connected via one or more networks, and software tasks and data storage may be distributed over one or more computers. Embodiments may also comprise one or more CPU instances implemented on a remote or local hardware virtual machine hosted on a local or remote computer system and operatively coupled to data storage media that is local and/or remote. A computer or computer system may be deployed in whole or in part on on-premises computer(s) or hardware appliance(s), or in the cloud. A computer system may include one or more web servers, application servers, or data servers.

The computers and computer systems described herein may include one or more server computers, desktop or personal computers, laptop computers, notebook computers, palm top computers, network computers, smart phone, tablet, or other mobile device, processor-controlled sensors or probes that connect and exchange data with other devices and systems over a network and which may be individually addressable, or any processor-controlled device capable of performing the steps, methods, and functions described herein.

The computer system may include computers or processors operating in parallel, including architectures in which some of the parallel computers or processors are remote and/or virtual machines. The computer system may include components located on different networked computers. The computer system may include a hyperscale environment or platform. The computer system may be implemented on one or more servers that perform the software functions in a hosted Software As A Service (SAAS) environment or Function as a Service (FAAS) environment or other computer architectures (for example, a client/server type architecture, a mainframe system with terminals, an ASP model, a peer to peer model, and the like.

The data storage media provide sufficient capacity to store data and program instructions to implement the methods and systems described herein. Data storage media refers generally to any operatively-coupled combination of one or more memory units and zero, one, or more data stores. “Memory units” may include any kind of memory, including RAM, flash memory, USB drives, ROM, or similar types of memory, and different kinds of memory units may be combined. Exemplary data stores or secondary storage devices may include disk controller, solid-state drive, hard disk drive, optical drive, CD-ROM or DVD, or other form of media capable of non-volatile data storage. A data store may also include “cloud” storage or other computers or servers operatively coupled to a computer system. In an embodiment, all data storage media are non-transitory. A data store may include one or more databases managed by a database management system. A database may include a SQL database, for example, postgresql, or other relational database. A database may include a NoSQL database, e.g., mongodb. A database may include a key-value store. A database may include an immutable data store.

A “network” as described herein may include a local area network, a wide area network, the Internet, the World Wide Web, Wi-Fi data network, Bluetooth or other radio connection, a wireless data network, a cellular data network, satellite network, or any other form of network connection that can link one or more computers or computer systems. A network may include any subnetwork.

Any “coupling” (or “operative coupling”) of computers, computer systems, or computer system components described herein may comprise close or local coupling, e.g., via a system bus, wired coupling (e.g., USB connection, Ethernet), wireless coupling (Wi-Fi connection or Bluetooth), remote coupling, e.g., via a network or Web connection. Any such coupling may support and enable communication of data and instructions between the computers, computer systems, or computer system components according to one or more communications protocols. A communications protocol may include a connection-oriented protocol for exchanging data or messages over a network. A communications protocol may include a transport-layer protocol, for example, Transmission Control Protocol (TCP). Input and output ports may include TCP ports. A communications protocol may include an applications layer protocol, for example, hypertext transfer protocol (HTTP). Any reference to HTTP may include extensions of HTTP, for example, Hypertext Transfer Protocol Secure (HTTPS).

The computers or computer systems may run or execute one or more software applications (or programs) to implement, execute and perform the steps, methods, algorithms, and functions described herein. The software applications (or software) may include program instructions (or processor-executable instructions) which when stored in memory can be executed by one or more processors or processing units to perform the steps, methods, and functions and implement the methods, systems and apparatus described and illustrated herein. The computers or computer systems may be programmed to run, implement, execute or perform the steps, methods, algorithms, and functions described herein by executing program instructions of the software applications (or programs).

The term “software application” as used herein includes software or program instructions designed to perform a specific task unrelated to the operation of the computer itself. The term “software application” as used herein also includes software or program instructions designed to perform a specific task related in whole or in part to the operation of the computer itself, e.g., utility software, or an operating system, kernel, or BIOS.

Those of skill will recognize that the techniques of the embodiments described herein may be implemented to advantage in a variety of sequential orders and that the present invention may be generally implemented in memory or other storage media, preferably non-transitory storage media, for introduction into and/or use by a computer system adapted for performing the steps, functions, and methods described and illustrated herein.

Applicant has provided code with this application: (a) java-truesbom-code is an example of Java code to be imported as a module in a Java application that provides the SBOM information; (b) hot.json illustrates an exemplary dynamic SBOM in JSON showing dependency information for currently-loaded deficiencies, which often differ compared to a static SBOM; and (c) cold.json illustrates exemplary SBOM information of compile-time dependencies provided by the SBOM module

Although embodiments of the present invention have been described in detail, it will be apparent to those skilled in the art that many embodiments taking a variety of specific forms and reflecting changes, substitutions and alterations can be made without departing from the spirit and scope of the inventions disclosed herein. The described embodiments illustrate the scope of the claims but do not restrict the scope of the claims.

What is claimed is:

1. An SBOM-reporting software program product embedded in non-transitory computer-readable medium, comprising program instructions stored thereon, that when executed on a processor, perform the steps of:
generating dynamic software bill of materials (SBOM) data for a software application during execution of the software application; and
outputting the dynamic SBOM data to a client via a communications network, wherein the program instructions for generating and outputting the dynamic SBOM data are included in the software application.

2. The SBOM-reporting software program product of claim 1, further comprising program instructions stored thereon, that when executed on a processor, perform the steps of:
receiving an SBOM request from the client via the communications network; and
generating the dynamic SBOM data in response to the SBOM request.

3. The SBOM-reporting software program product of claim 1, wherein the dynamic SBOM data comprises dependency identification data for all accessible and currently-loaded dependencies of the software application.

4. The SBOM-reporting software program product of claim 1, wherein the program instructions for generating and outputting dynamic SBOM data are comprised in an SBOM module that is a dependency of the software application.

5. The SBOM-reporting software program product of claim 4, wherein the dynamic SBOM data comprises dependency identification data for the SBOM module.

6. The SBOM-reporting software program product of claim 4, wherein the program instructions comprised in the SBOM module further comprise program instructions that perform listening for an SBOM request from the client on a communications port.

7. The SBOM-reporting software program product of claim 1, wherein the dynamic SBOM data is generated and output to the client on a configurable schedule.

8. The SBOM-reporting software program product of claim 1, wherein generating the dynamic SBOM data configurably occurs upon occurrence of an event or at a specified time

9. A computer system for locating potentially-exploitable software dependencies, comprising:
one or more computers comprising one or more SBOM-reporting software applications, wherein an SBOM-reporting software application is programmed to generate dynamic SBOM data for itself and report it; and
a computer-implemented SBOM server coupled via a computer network to the one or more computers, wherein the SBOM server is programmed to receive dynamic SBOM data from the one or more SBOM-reporting software applications and store said dynamic SBOM data in a computer-implemented dependency database coupled to the SBOM server.

10. The computer system for locating exploitable software dependencies of claim 9, wherein the one or more SBOM-reporting software applications self-report their dynamic SBOM data to the SBOM server.

11. The computer system for locating potentially-exploitable software dependencies of claim 10, wherein the one or more SBOM-reporting software applications self-report their dynamic SBOM data to the SBOM server on a configurable schedule.

12. The computer system for locating potentially-exploitable software dependencies of claim 10, wherein the one or more SBOM-reporting software applications are configurable to self-report their dynamic SBOM data to the SBOM server upon occurrence of an event.

13. The computer system for locating potentially-exploitable software dependencies of claim 9, wherein the SBOM server is further programmed to request dynamic SBOM data from the one or more SBOM-reporting software applications.

14. The computer system for locating potentially-exploitable software dependencies of claim 9, further comprising a computer-implemented SBOM collector coupled to the SBOM server, said SBOM collector being programmed to collect dynamic SBOM data from the one or more SBOM-reporting software applications and provide it to the SBOM server.

15. The computer system for locating potentially-exploitable software dependencies of claim 9, wherein the dynamic SBOM data reported by a SBOM-reporting software application comprises dependency identification data for all accessible and currently-loaded dependencies of the SBOM-reporting software application.

16. The computer system for locating potentially-exploitable software dependencies of claim 9, wherein the SBOM server is further programmed to provide a user interface that enables filtered searches of the dependency database, dependency tracking, alerts, and reporting to users.

17. The computer system for locating potentially-exploitable software dependencies of claim 9, wherein the SBOM server is further programmed to report an alert when dynamic SBOM data for a SBOM-reporting software application reveals the presence of a potentially-exploitable software dependency.

18. The computer system for locating potentially-exploitable software dependencies of claim 9, wherein a SBOM-reporting software application comprises an SBOM module that is programed to generate and output dynamic SBOM data for the software application, wherein the dynamic SBOM data reported by the SBOM module identifies the SBOM module as a loaded dependency of the SBOM-reporting software application.

19. The computer system for locating potentially-exploitable software dependencies of claim 9, wherein the one or more SBOM-reporting applications comprise a first SBOM-reporting application comprising a first SBOM module, said first SBOM-reporting application and first SBOM module written in a first programming language, and a second SBOM-reporting application comprising a second SBOM module, said second SBOM-reporting application and second SBOM module written in a different second programming language.

20. The computer system for locating potentially-exploitable software dependencies of claim 19, wherein the first SBOM module and the second SBOM module are programmed listen for an SBOM request on the same communications port number.
